(19) United States
(12) Patent Application Publication
(10) Pub. No.: US 2023/0132371 A9
(43) Pub. Date: Apr. 27, 2023

(54) SYSTEM, METHOD, AND COMPUTER-READABLE MEDIUM INCLUDING PROGRAM FOR PROVIDING LIVE VIDEO DISTRIBUTION SERVICE

(71) Applicant: DeNA Co., Ltd., Tokyo (JP)

(72) Inventors: Daisuke Mizuta, Tokyo (JP); Ryunosuke Hiruta, Tokyo (JP)

(73) Assignee: DeNA Co., Ltd., Tokyo (JP)

(21) Appl. No.: 17/453,750

(22) Filed: Nov. 5, 2021

(30) Foreign Application Priority Data
Nov. 6, 2020 (JP) 2020-186173

(51) Int. Cl. H04N 21/2187; H04N 21/258; H04N 21/234; H04N 21/233

(52) U.S. Cl. CPC H04N 21/2187; H04N 21/25891; H04N 21/23412; H04N 21/233

(57) ABSTRACT

According to one embodiment of the present invention, a live video distribution server helps users appropriately perform the live video distribution. The server provides users with a live video distribution (e.g., live streaming) service for distributing and watching live videos via the user terminals. The server generates advice information to a distributor and displays the advice information on a distributor screen. This configuration may allow users to perform the live video distribution while referring to the advice information presented in real-time.

### CROSS-REFERENCE TO RELATED APPLICATIONS

The present application claims the benefit of Japanese Patent Application No. JP2020-186173, filed on Nov. 6, 2020, the content of which is incorporated herein in its entirety by reference.

### TECHNICAL FIELD

The present invention relates to a system, method, and computer-readable medium including a program for providing a live video distribution (e.g., live streaming) service.

### BACKGROUND

Various services for distributing live videos have been conventionally provided (see Japanese Patent Application Publication No. 2019-022219 as an example). Such live video distribution services typically have various mechanisms to set the mood for a live performance. For example, these services allow viewers to enter comments or items while watching a live video. To satisfy the viewers, the users distributing the live video (distributor or streamer) try to respond to feedback, such as comments input by viewers watching their live videos.

However, inexperienced users may not appropriately respond to the feedback from viewers as described above. Given this, some agencies for educating and supporting distributing users have been established, but human efforts provided by such agencies alone may be insufficient to improve their skills.

One of the objects of the embodiments of the present invention is to help users appropriately perform the distribution of a live video. Other objects of the embodiments of the present invention will be made apparent with reference to the entire description.

### SUMMARY

A system according to one embodiment of the present invention includes one or more computer processors. The one or more computer processors execute machine-readable instructions to perform displaying a live video distributed by a distributing user on a first screen presented to a viewing user; generating advice information to the distributing user during distribution of the live video; and displaying the advice information on a second screen presented to the distributing user. In this system, the displaying of the advice information includes not displaying the advice information on the first screen.

A method according to one embodiment of the present invention is executed by one or more computers. The method includes displaying a live video distributed by a distributing user on a first screen presented to a viewing user; generating advice information to the distributing user during distribution of the live video; and displaying the advice information on a second screen presented to the distributing user. In this method, the displaying of the advice information includes not displaying the advice information on the first screen.

A non-transitory computer-readable medium according to one embodiment of the present invention includes a program. The program causes one or more computers to execute displaying a live video distributed by a distributing user on a first screen presented to a viewing user; generating advice information to the distributing user during distribution of the live video; and displaying the advice information on a second screen presented to the distributing user. In this program, the displaying of the advice information includes not displaying the advice information on the first screen.

Various embodiments of the present invention may help users appropriately perform the distribution of a live video.

### BRIEF DESCRIPTION OF THE DRAWINGS

FIG. 1 is a configuration diagram schematically illustrating a configuration of a network including a live video distribution server 10 according to an embodiment of the present invention.

FIG. 2 is a block diagram schematically illustrating functions of the live video distribution server 10.

FIG. 3 illustrates information managed in a user information table 411.

FIG. 4 is a diagram illustrating the rankings of users.

FIG. 5 illustrates information managed in a distribution management table 412.

FIG. 6 illustrates a top screen 60.

FIG. 7 illustrates information displayed in an individual display area 641.

FIG. 8 illustrates the top screen 60 in which “TOPICS” is selected in a filter area 62.

FIG. 9 illustrates information displayed in an individual display area 642.

FIG. 10 illustrates a distribution preparation screen 100.

FIG. 11 illustrates a distributor screen 70.

FIG. 12 illustrates a viewer screen 80.

FIG. 13 illustrates an item selection screen 200.

FIG. 14 is a flowchart illustrating a process executed by the server 10 for providing a distributor with advice information.

FIG. 15 is a flowchart illustrating a process executed by the server 10 when generating advice related to the viewer that has entered a virtual live streaming room.

FIG. 16 illustrates a comment display area 73 in which a comment object 731 corresponding to advice related to the viewer that has entered the live streaming room is added.

FIG. 17 illustrates a viewer screen 80A when a viewer is a supervisor of a distributor.

FIG. 18 is a flowchart illustrating a process executed by the server 10 to update users' rankings.

FIG. 19 is a diagram illustrating the rule for updating a ranking meter value.

FIG. 20 is a diagram illustrating the correspondence relationship between ranking update details and necessary ranking meter values.

FIG. 21 is a flowchart illustrating a process executed by the server 10 for giving virtual diamonds to users.

### DETAILED DESCRIPTION

Embodiments of the present invention will be described below with reference to the drawings. In the drawings, the same or equivalent components may be provided with the same or similar reference symbols.

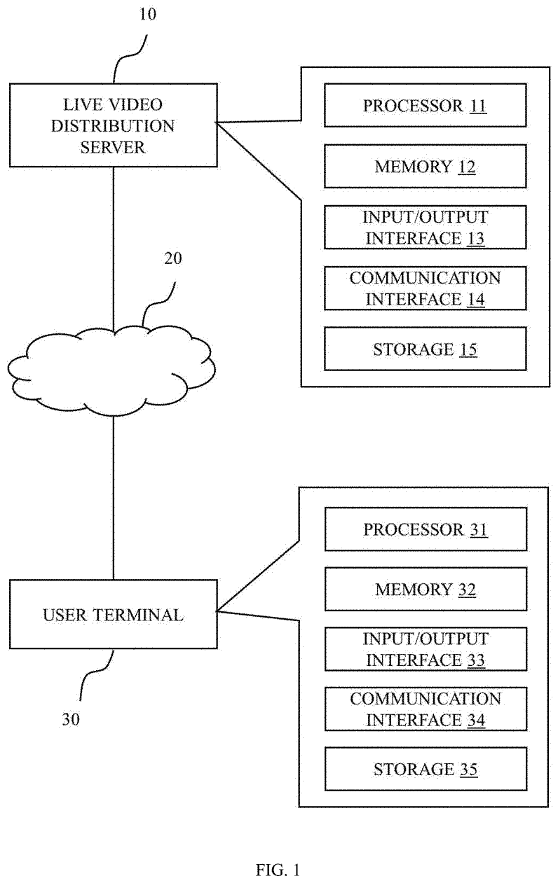

FIG. 1 is a configuration diagram schematically illustrating a configuration of a network including a live video distribution server 10 according to an embodiment of the present invention. As illustrated, the live video distribution server 10 communicably connects to a user terminal 30 via a communication network 20 such as the Internet. Only one user terminal 30 is illustrated in FIG. 1, but the server 10 communicably connects to a plurality of user terminals 30. The server 10 provides users with a live video distribution (e.g., live streaming) service for distributing and watching live videos via the user terminals 30. In the present embodiment, the user that operates the user terminal 30 can distribute (deliver) a live video as a distributor (streamer) and watch live videos provided by other users as a viewer. The live video distribution server 10 is an example of devices that achieve all or a part of the system of the present invention.

The hardware configuration of the live video distribution server 10 will be described. The live video distribution server 10 is configured as a typical computer. As illustrated in FIG. 1, the server 10 includes a computer processor 11, a main memory 12, an input/output interface 13, a communication interface 14, and a storage 15. These components are electrically connected via a bus (not illustrated) or the like.

The computer processor 11 is configured as a CPU, a GPU, or the like, reads various kinds of programs stored in the storage 15 or the like into the main memory 12 and executes various kinds of commands (instructions) included in the programs. The main memory 12 is constituted with a DRAM, for example.

The input/output interface 13 includes various input/output devices for exchanging information with an operator or the like. The input/output interface 13 includes, for example, an information input device such as a keyboard and a pointing device (for example, a mouse, a touch panel, and the like), a sound input device such as a microphone, and an image input device such as a camera. The input/output interface 13 includes an image output device such as a display and a sound output device such as a speaker.

The communication interface 14 is implemented as hardware such as a network adapter, various kinds of communication software, and combinations thereof. It is configured to achieve wired or wireless communication via the communication network 20 or the like.

The storage 15 is constituted with a magnetic disk, a flash memory, or the like. The storage 15 stores various programs, including an operating system, various kinds of data, and the like.

In the present embodiment, the live video distribution server 10 may be configured with a plurality of computers, each having the hardware configuration described above. For example, the live video distribution server 10 may be constituted with one or more server devices.

The live video distribution server 10 configured in such a manner may function as a web server and an application server. In this case, the live video distribution server 10 executes various kinds of processing in response to a request from a web browser and other applications (such as an application for the live video distribution service) installed on the user terminal 30 and transmits, to the user terminal 30, screen data (such as HTML data), control data, and the like according to a result of the processing. The user terminal 30 may display a web page or another screen based on the received data.

The hardware configuration of the user terminal 30 will be described below. The user terminal 30 is configured as a typical computer. As illustrated in FIG. 1, the user terminal 30 includes a computer processor 31, a main memory 32, an input/output interface 33, a communication interface 34, and a storage 35. These components are electrically connected via a bus (not illustrated) or the like.

The computer processor 31 is configured as a CPU, a GPU, or the like, reads various kinds of programs stored in the storage 35 or the like into the main memory 32 and executes various kinds of commands (instructions) included in the programs. The main memory 32 is constituted with a DRAM, for example.

The input/output interface 33 includes various input/output devices for exchanging information with an operator or the like. The input/output interface 33 includes, for example, an information input device such as a keyboard and a pointing device (for example, a mouse, a touch panel, and the like), a sound input device such as a microphone, and an image input device such as a camera. The input/output interface 33 includes an image output device such as a display and a sound output device such as a speaker.

The communication interface 34 is implemented as hardware such as a network adapter, various kinds of communication software, and combinations thereof. It is configured to achieve wired or wireless communication via the communication network 20 or the like.

The storage 35 is constituted with a magnetic disk, a flash memory, or the like. The storage 35 stores various programs, including an operating system, various kinds of data, and the like. The programs stored in the storage 35 may be downloaded from an application market or the like and then installed.

In the present embodiment, the user terminal 30 may be configured as a smartphone, a tablet terminal, a personal computer, a wearable device, or the like.

The user that operates the user terminal 30 having the above configuration can use a live video distribution service provided by the live video distribution server 10 by executing communication with the server 10 via a web browser or another application installed in the storage 35 or the like.

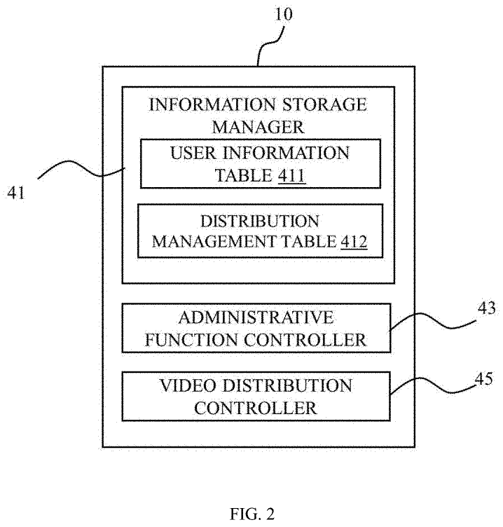

Next, functions of the live video distribution server 10 having the above configuration will be described. FIG. 2 is a block diagram schematically illustrating the functions of the live video distribution server 10. As shown, the server 10 includes an information storage manager 41 that stores and manages various kinds of information, an administrative function controller 43 that controls administrative functions of the live video distribution service, and a video distribution controller 45 that controls the distribution of videos. These functions are achieved by a cooperative operation of hardware, such as the computer processor 11 and the main memory 12, and various programs and data stored in the storage 15 and the like. For example, the functions are achieved by the computer processor 11 executing commands included in programs loaded into the main memory 12. In addition, some or all of the functions of the server 10 illustrated in FIG. 2 may be achieved by a cooperative operation of the server 10 and the user terminal 30 or can be achieved by the user terminal 30.

The information storage manager 41 stores and manages various kinds of information in the storage 15 and the like. For example, as illustrated in FIG. 2, the information storage manager 41 has a user information table 411 for managing information related to a live video distribution service user and a distribution management table 412 for managing information related to individual live videos distributed.

The administrative function controller 43 executes various kinds of processing related to the control of administrative functions of the live video distribution service. For example, the administrative function controller 43 transmits data, such as screen data and control data, for various screens related to the administrative functions to the user terminal 30, executes various kinds of processing in response to an operation input by the user via the screen displayed on the user terminal 30, and transmits data, such as the screen data and the control data, according to a result of the processing to the user terminal 30. The administrative functions controlled by the administrative function controller 43 include, for example, login processing (user authentication), fee-charging control, and user management (e.g., updating the user information table 411).

The video distribution controller 45 executes various kinds of processing related to controlling the distribution of videos. For example, the video distribution controller 45 is configured to distribute a live video provided by a distributor (distributing user) to a plurality of viewers (viewing users). For example, the video distribution controller 45 is configured to receive a live video transmitted from the user terminal 30 of a distributor (hereinafter sometimes referred to as a “distributor terminal 30”) and then send the live video to the user terminals 30 of the plurality of viewers (hereinafter sometimes referred to as a “viewer terminal 30”). In the viewer terminal 30, the live video is displayed (played back) on a viewer screen used by a viewer. The live video consists of, for example, images input via a camera of the distributor terminal 30 and sounds input via a microphone of the distributor terminal 30. Alternatively, the live video may consist of images and sounds output by an application, such as a game application, executed on the distributor terminal 30. Such a live video may be distributed by, for example, a streaming method using a protocol such as HTTP Live Streaming (HLS).

In the present embodiment, the video distribution controller 45 is configured to generate advice information to a distributor and then display the advice information on a distributor screen presented to the distributor. For example, the video distribution controller 45 may be configured to transmit screen data and control data for the distributor screen, including the generated advice information, to the distribution terminal 30.

In the present embodiment, the advice information to the distributor is configured not to be displayed on the viewer screen. That is, the server 10 prevents the advice information from displaying on the viewer screen. For example, the video distribution controller 45 transmits the advice information to the distributor terminal 30, not to the viewer terminal 30. Alternatively, the video distribution controller 45 transmits the advice information to the distributor terminal 30 and the viewer terminal 30. However, the viewer screen displayed on the viewer terminal 30 may be configured not to show the received advice information.

As described above, the live video distribution server 10 according to the present embodiment, generates the advice information to a distributor and displays the advice information on the distributor screen. This configuration may allow users to perform the distribution of a live video while referring to the advice information presented in real-time. Thus, the live video distribution server 10 may help users appropriately perform the live video distribution.

In the present embodiment, the advice information to a distributor may be generated based on various kinds of information and may be generated and displayed at various times. For example, the video distribution controller 45 is configured to generate the advice information based at least on viewer information related to a viewer. The viewer information includes but is not limited to basic information (such as age, gender, and an area of residence), use history (such as login history to the service, viewing history of live videos, and history of actions (e.g., inputting a comment) while watching the live video), and update history of a viewer's profile. The advice information is generated based on the viewer information of an individual viewer or the viewer information of a plurality of viewers (e.g., viewers watching the live video at that time). This configuration may provide a distributor with advice information based on the viewer information, thus enhancing good communication between the distributor and viewers.

The video distribution controller 45 may be configured to display the advice information related to a viewer on the distributor screen when this viewer performs a predetermined action. The predetermined action includes but is not limited to starting to watch the live video (entering a virtual live video distribution room), entering a predetermined number (one or more) of comments, and entering or consuming a predetermined number (one or more) of items. This configuration may provide a distributor with the advice information related to a viewer that has performed the action, thus enhancing good communication between the distributor and the viewer.

The video distribution controller 45 may be configured to generate the advice information based at least on information input by a supervisor of a distributor (e.g., a person in charge of an agency that supports the distributor). The correspondence relationship between distributors and supervisors may be managed in the user information table 411. For example, a supervisor may input advice to a distributor via the viewer screen displaying a live video provided by this distributor. Alternatively, the supervisor may input the advice via a supervisor screen that the supervisor uses and is different from the viewer screen. This configuration may provide a distributor with advice information based on information input by a supervisor of the distributor.

The video distribution controller 45 may be configured to generate the advice information based at least on distribution performance information related to the performance of live video distribution. The distribution performance information may include but is not limited to information such as distribution duration, the current time, the number of viewers (current or maximum value), the number of comments or items input. This configuration may provide a distributor with advice information based on information related to the performance of live video distribution.

The video distribution controller 45 may be configured to generate the advice information based at least on distributor information related to a distributor. The distributor information may include but is not limited to basic information (such as age, gender, and an area of residence), ranking information (such as ranking of distributors in an event), and distribution history. This configuration may provide a distributor with advice information based on the distributor information.

The video distribution controller 45 may be configured to generate the advice information based at least on external service information obtained from external services. The external services may include but are not limited to an SNS, a content (such as music, games, news, and books) distribution service, and the like. For example, the advice information may be generated based on trend information in the SNS. This configuration may provide a distributor with advice information based on the external service information.

The video distribution controller 45 may be configured to generate the advice information through analysis of images and/or audio included in the live video being distributed. For example, the video distribution controller 45 analyzes a distributor's face (expression) included in the live video to generate the advice information. In addition, the video distribution controller 45 may analyze the distributor's voices (emotion) included in the live video to generate the advice information. This configuration may provide a distributor with the advice information based on real-time analysis of images and audio included in a live video being distributed.

In the present embodiment, the advice information may be displayed in various ways on the distributor screen. For example, the advice information may be displayed like subtitles at the predetermined location on the distributor screen.

The video distribution controller 45 may be configured to display a comment corresponding to the advice information in a comment display area included in the distributor screen. The comment display area shows at least comments corresponding to actions (such as starting to watch a live video and entering a comment or an item) performed by viewers. Typically, a plurality of comments is arranged in order of occurrence in the comment display area. This configuration may provide a distributor with the advice information via the comment display area, thus improving the visibility of the advice information.

In the present embodiment, the comment corresponding to the advice information may be displayed differently from other comments. In other words, the comment display area of the distributor screen may be configured to display the comments corresponding to actions performed by viewers in a first manner and the comments corresponding to the advice information in a second manner that is different from the first manner. The differences between the first and second manners may include but are not limited to the text color of a comment, background, and shape and outline of an object displaying comments. This configuration may improve the visibility of the advice information in the comment display area.

The video distribution controller 45 may be configured to display, in the comment display area, the comments corresponding to the advice information related to a viewer next to the comment corresponding to an action performed by this viewer. This configuration may provide a distributor with the advice regarding a viewer while relating this advice to an action of this viewer.

Next, a specific example of the live video distribution server 10 according to the present embodiment having such functions will be described. In this example, the live video distribution service is configured to be a live streaming service allowing users to stream and watch a live video formed of images input via the camera of the distributor terminal 30 and sounds input via the microphone of the distributor terminal 30.

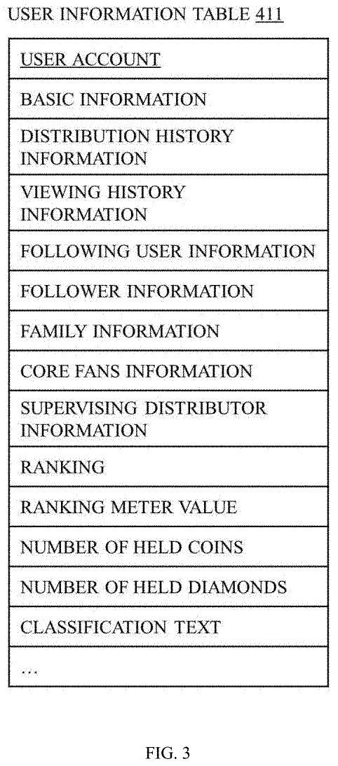

FIG. 3 illustrates information managed in the user information table 411 in this example. The user information table 411 manages information related to a user of the live streaming service. As illustrated, the table 411 manages, in association with “user account” that identifies an individual user, information such as “basic information”, which includes an account name, age, gender, an area of residence, profile information and the like; “distribution history information”, which is information related to the history of live video distribution (live streaming) conducted by the user as a distributor; “viewing history information”, which is information pertaining to the history of watching live videos as a viewer; “following user information”, which is information related to other users followed by the user; “follower information”, which is information related to other users (followers) that are following the user; “family information”, which is information pertaining to the “family” that the user is a member of; “core fans information”, which is information related to other users that the user is a member of the “core fans” of; “supervising distributor information”, which is information related to a distributor supervised by the user; “ranking”, which indicates a ranking of the user as a distributor; “ranking meter value”, which is a parameter value for determining whether to increase or decrease the ranking; “number of held coins”, which indicates how many virtual coins are held in the live streaming service; “number of held diamonds”, which means how many virtual diamonds are held in the live streaming service; and “classification text”, which indicates a classification set by the user as a distributor.

In this example, the “family” is a community of fans that support a particular distributor. Users can join the “family” in response to an invitation from the distributor or the administrator of the “family”. Also, users can join the “family” when the distributor or the administrator of the “family” approves their requests to join. In addition, the “core fans” are users that support the distributor as fans and have achieved the conditions related to their actions as viewers. Specifically, the conditions for becoming a member of “core fans” are the number of comments, viewing duration, and the number of coins consumed to reach corresponding predetermined values. The viewing history information may include information related to actions performed by viewers for each distributor.

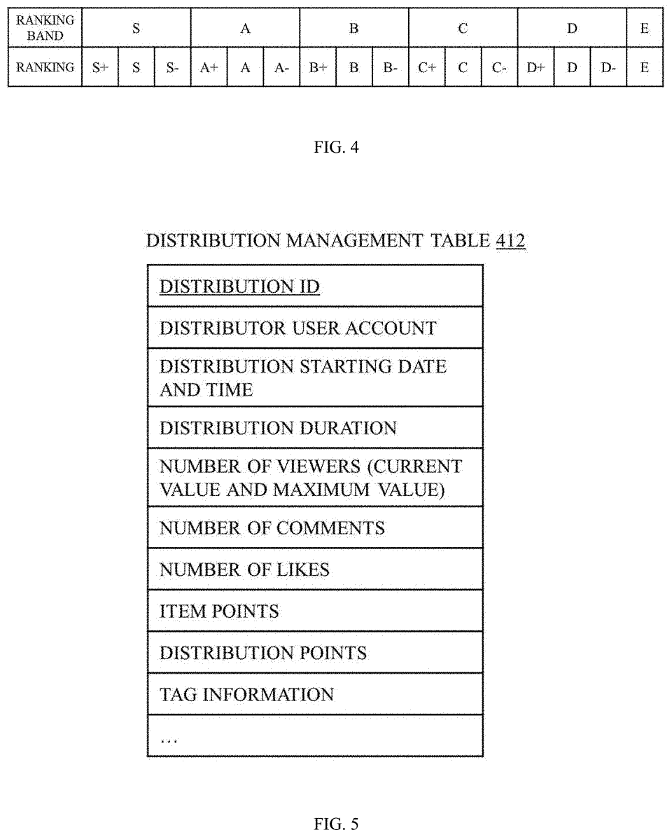

FIG. 4 is a diagram illustrating the rankings of distributors in this example. As shown, there are six ranking bands of “S”, “A”, “B”, “C”, “D”, and “E”. Each of the five ranking bands of “S”, “A”, “B”, “C”, and “D” has three rankings (for example, a ranking in which “+” is added to a letter indicating a ranking band, a ranking with just the letter, and a ranking in which “−” is added to the letter, such as “S+”, “S”, and “S−”). The ranking band of “E” has one ranking, “E”. That is, there are 16 levels (3×5+1=16) of rankings in this example.

Furthermore, among the ranking bands, the “S” side is the highest, and the “E” side is the lowest. Among the rankings in the same ranking band, the “+” side is the highest, and the “−” side is the lowest. In this example, a user's ranking is set to “D−” as the initial value.

FIG. 5 illustrates information managed in the distribution management table 412 in this example. The distribution management table 412 manages information related to individual live videos distributed. As shown, the distribution management table 412 manages, in association with “distribution ID” that identifies an individual live video distributed, information such as “distributor user account”, which identifies a user distributing the live video; “distribution starting date and time”; “distribution duration”, which indicates a continuous duration of the distribution; “number of viewers (current value and maximum value)”; “number of comments”, which is the number of comments input by viewers; “number of likes”, which is the number of “likes” input by viewers; “item points”, which increase according to viewers' inputting items; “distribution points”, which are points given for the distribution; and “tag information”, which is information related to tags attached to the live video.

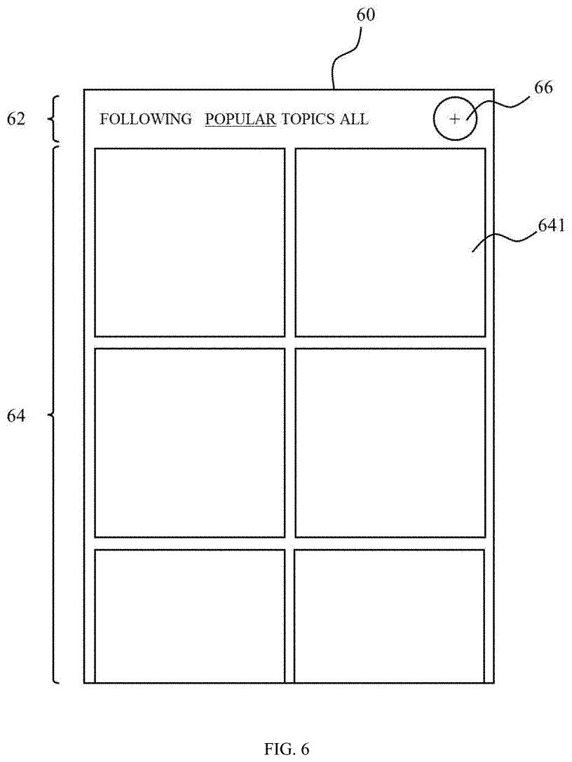

FIG. 6 illustrates a top screen 60 of the live streaming service displayed on the user terminal 30. The screen 60 is a screen as a starting point for users of the live streaming service. As illustrated, the screen 60 has a filter area 62 in which “FOLLOWING”, “POPULAR”, “TOPICS”, and “ALL” are displayed, a list display area 64 located under the area 62, and a circular distribution button 66 located at the upper-right corner of the screen.

The filter area 62 is an area that allows users to set filtering for the live videos (live streams) displayed in the list display area 64. Specifically, when a user selects “FOLLOWING” in the filter area 62, the live videos listed in the list display area 64 are narrowed down to the live videos of the other users followed by the user. Similarly, when a user selects “POPULAR” in the filter area 62, the live videos listed in the list display area 64 are narrowed down to the live videos extracted according to a predetermined extraction condition for extracting popular videos. The predetermined extraction conditions include, for example, the condition that the number of viewers (current value) is more than or equal to a threshold value. When a user selects “TOPICS” in the filter area 62, the tags attached to live videos are chronologically (in order of attached time) displayed in a list together with corresponding live videos in the list display area 64. When a user selects “ALL” in the filter area 62, all live videos are subject to be listed in the list display area 64.

The top screen 60 in FIG. 6 corresponds to a case where a user selects “POPULAR” in the filter area 62. As illustrated, in the list display area 64 in this case, a plurality of individual display areas 641, each of which displays information related to a particular live video, are arranged in two columns. The individual display area 641 is configured to start watching the corresponding live video by the selection. In addition, the list display area 64 is configured to switch a plurality of individual display areas 641 to be displayed by a flicking or sliding operation (input) in the up and down direction. The layout of the list display area 64 when a user selects “FOLLOWING” or “ALL” in the filter area 62 is like the above-described layout when a user selects “POPULAR”.

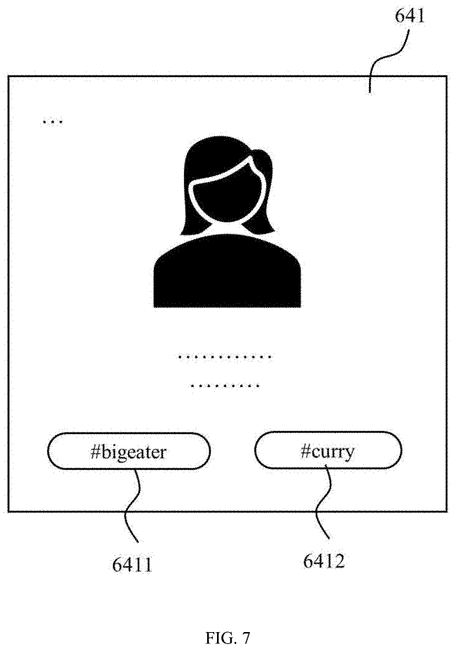

FIG. 7 illustrates information displayed in the individual display area 641. The individual display area 641 shows an image preset by a distributor of a live video, an account name of the distributor, the number of viewers (current value), and the like. Also, at the lower end of the individual display area 641, a first tag object 6411 and a second tag object 6412 are located and horizontally aligned. The first tag object 6411 displays a classification text in a hashtag form, in which “#” is added to a head of a character string. The classification text is the classification of the distributor set by themself and is managed in the user information table 411. In FIG. 7, the first tag object 6411 displays “#bigeater”. In addition, the second tag object 6412 similarly displays the newest tag attached to the corresponding live video by a viewer in the hashtag form. In FIG. 7, the second tag object 6412 displays “#curry”.

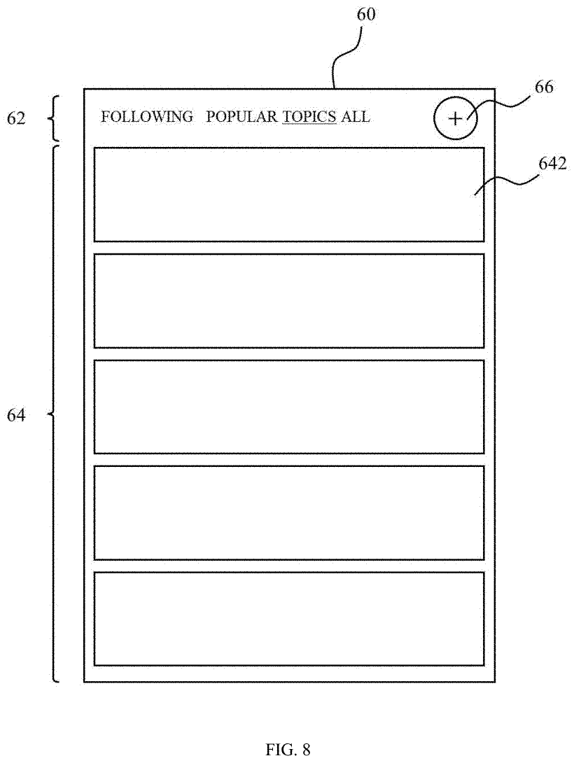

FIG. 8 illustrates the top screen 60 when “TOPICS” is selected in the filter area 62. In the top screen 60 in this case, the list display area 64 displays the tags attached to any live videos to be chronologically arranged together with the live videos to which the tags are attached. In other words, in the list display area 64 when “TOPICS” is selected in the filter area 62, the tags arranged in descending order of attached date and time and the corresponding live videos (i.e., live videos to which the tags are attached respectively) are displayed in a list.

In the list display area 64, a plurality of individual display areas 642, each displaying information related to a particular tag and a corresponding live video, are arranged in the up and down direction. When a new tag is attached to any live video, the corresponding individual display area 642 is added to the top of the list display area 64.

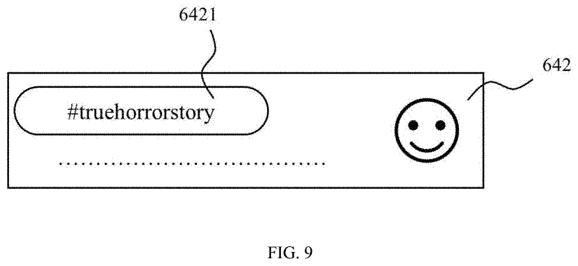

FIG. 9 illustrates information displayed in the individual display area 642. As shown, a tag object 6421 is disposed at the upper-left corner of the area 642. In addition, the area 642 displays information of a distributor of the corresponding live video (i.e., a live video to which the tag is attached) such as a profile image, an account name, and the like. Furthermore, a link to the corresponding live video is set on the individual display area 642. A user can start watching the related live video by selecting any of the plurality of individual display areas 642 displayed in the list display area 64.

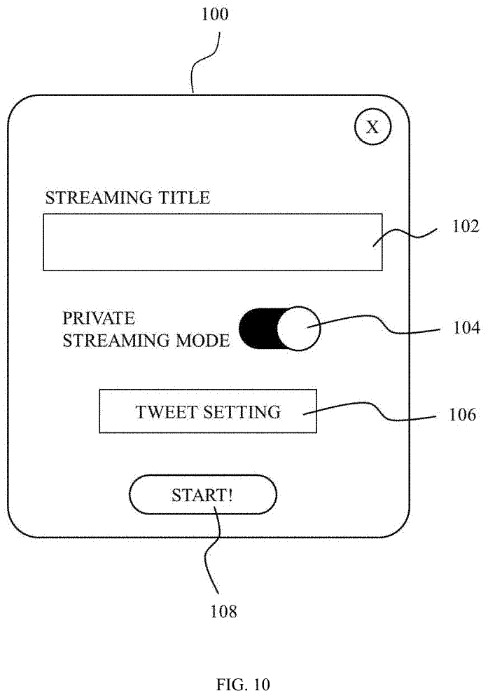

The distribution button 66 of the top screen 60 is an object that allows a user as a distributor to perform live streaming. When the distribution button 66 is selected by the user, a distribution preparation screen 100 illustrated in FIG. 10 is displayed over the top screen 60. As shown, the screen 100 includes a streaming title input area 102 for inputting a streaming title, a private streaming setting switch 104 for setting a private streaming mode, a tweet setting button 106 for performing settings related to the tweet (posting a message on an SNS) automatically conducted during live streaming, and a distribution start button 108 with “start!” displayed. The secret streaming is a live streaming mode in which only a new viewer (specifically, a viewer whose total viewing duration of live videos provided by the corresponding distributor in a predetermined period is less than a predetermined value) can watch the live video.

When a user selects the distribution start button 108, the live streaming starts. Specifically, the video formed of images input via the camera of the user terminal 30 and sounds input via the microphone of the user terminal 30 starts to be transmitted to the server 10. In addition, a new record is created in the distribution management table 412 in response to the live streaming starting.

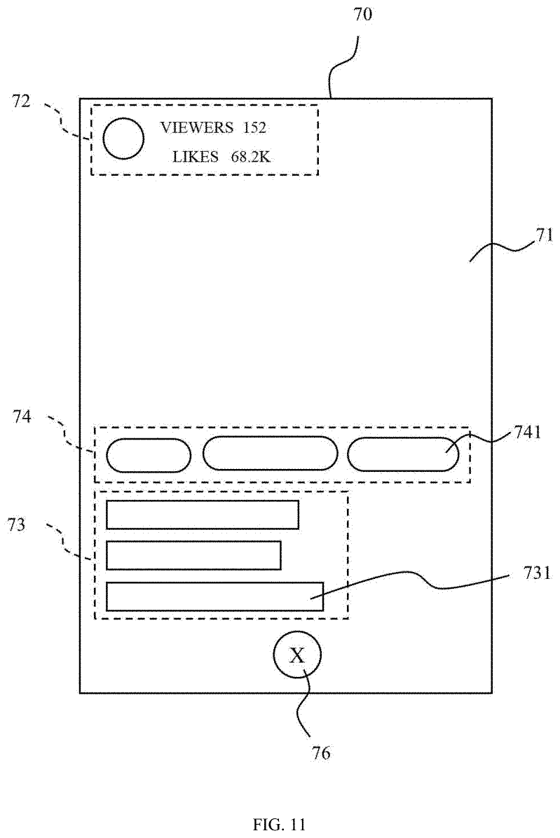

FIG. 11 illustrates a distributor screen 70 displayed on the distributor terminal 30 when a user selects the distribution start button 108 (i.e., the live streaming starts). As illustrated, the screen 70 includes a video display area 71 corresponding to the entire screen, a basic information display area 72 located at the upper-left corner of the screen, a comment display area 73 located at the lower-left corner of the screen, a tag display area 74 located above the area 73, and a circular distribution stop button 76 located at the center of the bottom edge of the screen.

The video display area 71 displays a moving image included in a live video (i.e., images input via the camera of the distributor terminal 30). The distributor usually makes themself the subject of the video via the in-camera of the distributor terminal 30. Thus, a moving image of the distributor is included in the live video.

The basic information display area 72 displays basic information of the live streaming. Specifically, the basic information of the live streaming includes the distributor information (such as a profile image), the number of viewers (current value), and the number of “likes” input by viewers.

The comment display area 73 is an area for displaying user comments input by viewers and displaying system comments input automatically by the server 10. Specifically, a plurality of comment objects 731, each corresponding to an individual comment, are arranged in the up and down direction in the area 73. The comment display area 73 is configured such that, when a new comment is entered, the corresponding comment object 731 is added to the bottom of the area 73, and the existing comment objects 731 sequentially move upward. In addition, the comment display area 73 is configured such that the comment objects 731 to be displayed are switched by a flicking or sliding operation (input) in the up and down direction.

The tag display area 74 displays information related to tags attached to the live video. Specifically, a plurality of tag objects 741, each corresponding to an individual tag, are located and horizontally aligned in the area 74.

The distribution stop button 76 is an object that allows a distributor to stop live streaming. When a distributor selects the distribution stop button 76, the live streaming (i.e., the live video transmission from the distributor terminal 30 to the server 10) stops.

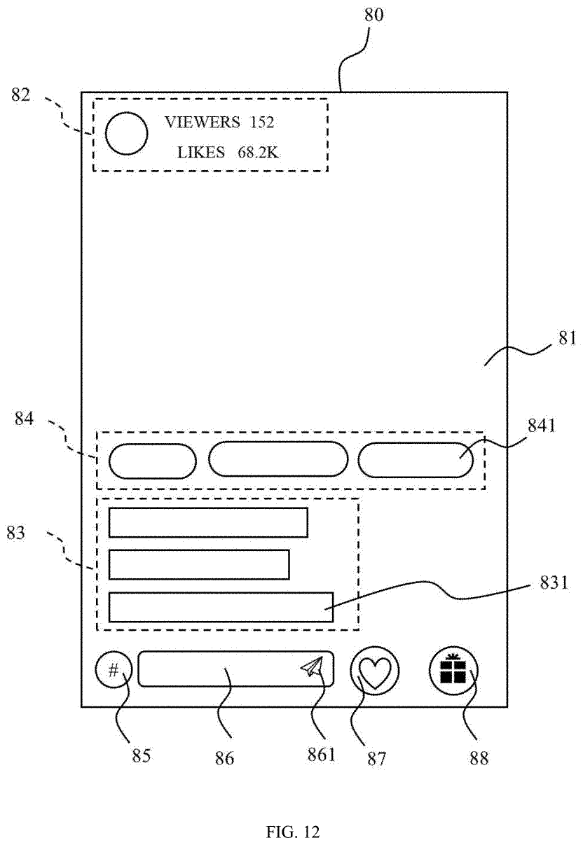

FIG. 12 illustrates a viewer screen 80 displayed on the viewer terminal 30. For example, when a viewer selects any live video in the list display area 64 of the top screen 60 or the like, the viewer screen 80 for watching the selected live video is displayed on the viewer terminal 30. As illustrated, the screen 80 has a video display area 81, a basic information display area 82, a comment display area 83, and a tag display area 84, which are like the distributer screen 70 described above. In addition, the viewer screen 80 has at the bottom edge of the screen, an input mode switching button 85, a comment input area 86, a “like” button 87 with a heart mark displayed, and an item input button 88 with a symbol of a gift displayed.

The comment input area 86 is an area that allows a viewer to input a comment or tag. While the input mode switching button 85 is not selected, the comment input area 86 is in a regular comment input mode. In the comment input mode, a character string input in the comment input area 86 is transmitted as a user comment when the transmission object 861 located at the right edge of the comment input area 86 is selected. Subsequently, the comment object 731 corresponding to the user comment is ready to be displayed in the comment display area 73 of the distributor screen 70 displayed on the corresponding distributor terminal 30 (i.e., the user terminal 30 operated by the distributor of the live video). Similarly, the comment object 831 corresponding to the user comment is ready to be displayed in the comment display area 83 of the viewer screen 80 displayed on each of viewer terminals 30 (i.e., each of a plurality of user terminals 30 operated by a plurality of viewers viewing the live video). The comment objects 731 and 831, each corresponding to the user comment, display the account name of the viewer that has input the comment together with the comment body (text). In addition, when a user comment is transmitted, the server 10 updates (adds one to) the number of comments in the distribution management table 412.

On the other hand, the comment input area 86 is in a tag input mode while the input mode switching button 85 is selected. A character string input in the comment input area 86 is transmitted as a tag in the tag input mode when the transmission object 861 is selected. Then the tag is attached to (associated with) the live video. In this example, the viewers that can input a tag are limited to the “family” members of the corresponding distributor. Specifically, the input mode switching button 85 of the viewing screen 80 can be selected (is effective) when the viewer is the “family” member of the corresponding distributor. On the other hand, the input mode switching button 85 cannot be selected (is disabled) when the viewer is not the “family” member of the corresponding distributor. In addition, the number of tags that can be attached during the predetermined period is limited. In particular, the number of tags that can be attached within 5 minutes is limited to three.

When a tag is attached, the tag object 741 corresponding to the attached tag is ready to be displayed in the tag display area 74 of the distribution screen 70 displayed on the corresponding distributor terminal 30. Similarly, the tag object 841 corresponding to the attached tag is ready to be displayed in the tag display area 84 of the viewer screen 80 displayed on each viewer terminal 30. In the tag display areas 74 and 84, the tag objects 741 and 841 are located and horizontally aligned such that the objects 741 and 841 located on the left side are newer (with a later attached time). Accordingly, the tag objects 741 and 841, each corresponding to a newly attached tag, are added to the left end in the tag display areas 74 and 84. When the time elapsed since the corresponding tag has been attached reaches 5 minutes, the tag objects 741 and 841 are deleted. For example, the tag objects 741 and 841 disappear with an animation effect of moving in the right direction.

In this example, the tag objects 741 and 841 display the tag's content in hashtag form in which “#” is added to a head of a character string. For example, when the tag's content is “Tokyo tour”, “#tokyotour” is displayed in the corresponding tag objects 741 and 841. In addition, the horizontal length of the tag objects 741 and 841 automatically adjusts to the length of a character string displayed thereon.

Furthermore, when a tag is attached, the comment objects 731 and 831, each corresponding to a system comment notifying that the tag is attached, are ready to be displayed in the comment display area 73 of the distribution screen 70 and in the comment display area 83 of the viewer screen 80. The comment objects 731 and 831, each corresponding to this system comment, display the attached tag's content together with an account name of a viewer that has attached (input) the tag. For example, a comment such as “xx tagged this live video with ‘tokyotour.’” is displayed. In addition, when a tag is attached, the tag information in the distribution management table 412 is updated.

The “like” button 87 is an object that allows a viewer to input a “like” for a distributor (live video). When a viewer selects the button 87, a “like” is input, and the comment objects 731 and 831, each corresponding to a system comment notifying that the “like” has been input, are ready to be displayed in the comment display area 73 of the distributor screen 70 displayed on the corresponding distributor terminal 30 and in the comment display area 83 of the viewer screen 80 displayed on each viewer terminal 30. The comment objects 731 and 831, each corresponding to this system comment, display the account name of the viewer that has input the “like” with the text indicating that the “like” is input. In addition, when a “like” is input, a predetermined visual effect (e.g., an animation effect in which heart-shaped objects are displayed as flowing from the bottom to the top of the screen) is added in the video display areas 71 and 81. Furthermore, when a “like” is input, the server 10 updates (adds one to) the number of “likes” in the distribution management table 412.

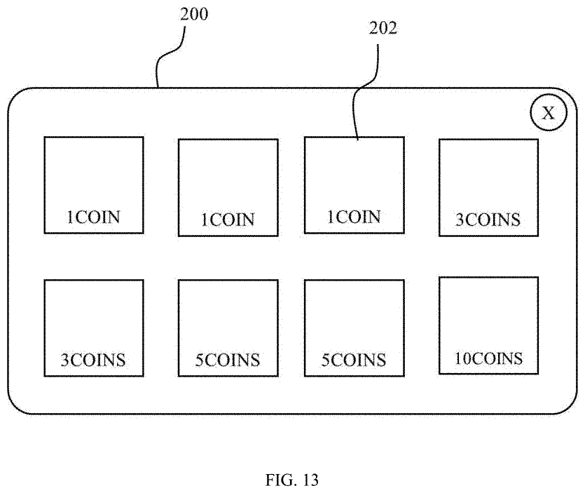

The item input button 88 is an object that allows a viewer to input an item. When a viewer selects the button 88, an item selection screen 200 illustrated in FIG. 13 is displayed over the viewer screen 80. As shown, the screen 200 displays a list of individual display areas 202, each displaying information related to an item. The individual display area 202 displays an image corresponding to the item and the number of coins required to input this item.

In this example, a plurality of items that a viewer can input is predetermined, and each item has the number of coins as a price (which can be called a “value”). The item selection screen 200 displays a list of the plurality of items that a viewer can input. When a viewer selects any of the plurality of items via the item selection screen 200, the selected item is input.

When an item is entered, the comment objects 731 and 831, each corresponding to a system comment notifying that an item is entered, are ready to be displayed in the comment display area 73 of the distributor screen 70 displayed on the corresponding distributor terminal 30, and in the comment display area 83 of the viewer screen 80 displayed on each viewer terminal 30. The comment objects 731 and 831, each corresponding to this system comment, display the account name of the viewer that has input the item with the item's name. In addition, when an item is entered, a predetermined visual effect corresponding to the input item is added in the video display areas 71 and 81. Furthermore, when an item is entered, the server 10 gives this live video the item points based on the number of coins required to input this item. Specifically, the server 10 adds points according to the number of coins to the number of item points for the corresponding live video in the distribution management table 412. The number of item points to be given increases as the number of coins required to input the item increases, for example. In addition, when an item is entered, the server 10 subtracts the number of coins corresponding to the input item from the number of held coins for the corresponding user (the viewer that has input the item) in the user information table 411.

When a new viewer starts watching the live video (i.e., enters the live streaming room), the comment object 731 corresponding to a system comment notifying that the viewer has entered the room is ready to be displayed in the comment display area 73 of the distributor screen 70 displayed on the corresponding distributor terminal 30. Similarly, the comment object 831 corresponding to the system comment notifying that the viewer has entered the room is ready to be displayed in the comment display area 83 of the viewer screen 80 displayed on each viewer terminal 30. The comment objects 731 and 831, each corresponding to this system comment, display the account name of the viewer that has started watching the live video (has entered the live streaming room) and the like.

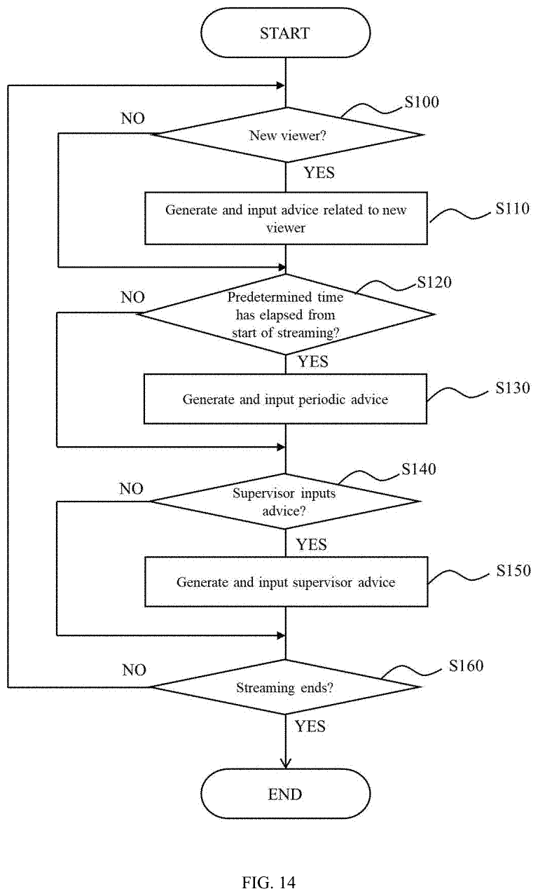

Next, the process related to providing advice information to distributors will be described. FIG. 14 is a flowchart illustrating the process executed by the server 10 for providing the advice information during live streaming. As shown, the server 10 waits, until the live streaming ends (NO in step S160), for a viewer to enter a live streaming room (step S100), for the predetermined time to elapse (step S120), or for a supervisor to input advice (step S140). Then, each time a new viewer enters the live streaming room (i.e., a new viewer starts watching the live video) (YES in step S100), the server 10 generates and inputs the advice related to the new viewer that has entered the room (step S110).

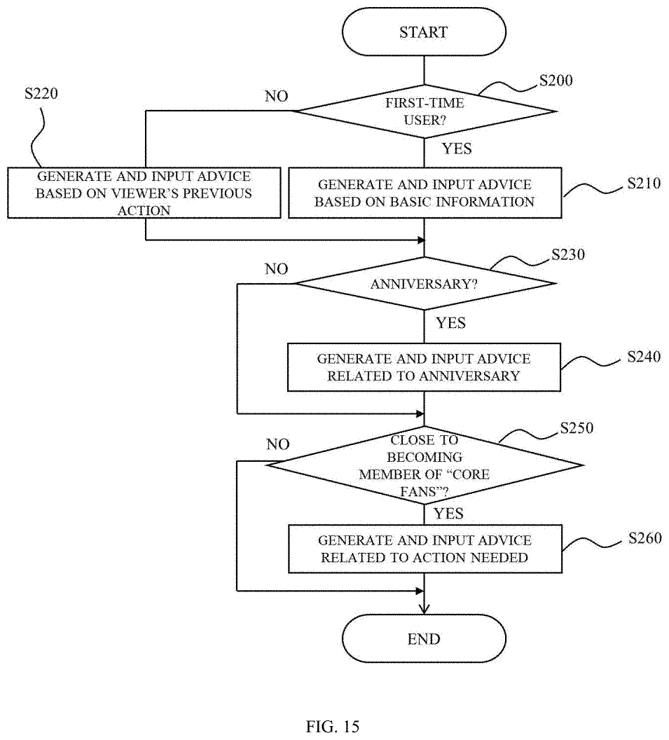

In this example, the server 10 generates one or more pieces of advice based on various kinds of information related to the viewer. FIG. 15 is a flowchart illustrating the process executed by the server 10 for generating the advice related to the new viewer that has entered the live streaming room. As illustrated, when the viewer that has entered the room is a first-time user (i.e., a user that watches the live video provided by the corresponding distributor for the first time) (YES in step S200), the server 10 generates and inputs the advice based on the basic information related to the viewer (step S210). Specifically, the server 10 in this example generates and inputs the advice recommending topics according to the viewer's area of residence, which is managed as a part of the basic information in the user information table 411.

For example, the advice recommending the topics based on the viewer's area of residence is set as a message in the form of “[viewer's name]'s area of residence is [name of residence area]. Please try to talk about [topic's name]!” In this form, a portion in the square brackets ([]) is a character variable and is set to the specific value according to the information on the individual viewer. For example, [name of residence area] is set to the name of the viewer's area of residence (e.g., “Osaka”), and the [topic's name] is set to the name of the topic corresponding to the area of residence (e.g., “Osaka Expo”). The correspondence relationship between areas of residence and topics is set in advance. This correspondence is updated as needed by the live streaming service's operator, the agency that supervises the distributor, or the like.

When the advice is input, the comment object 731 corresponding to a system comment displaying the content of the input advice is added to the comment display area 73 of the distributor screen 70 to be ready to be displayed. On the other hand, even when the advice is input, the corresponding comment object 831 is not added to the comment display area 83 of the viewer screen 80.

When the viewer that has entered the live streaming room is not a first-time user (NO in step S200), the server 10 generates and inputs the advice based on the viewer's previous action (step S220). Specifically, the server 10 in this example generates and inputs the advice recommending topics based on the date and time of the viewer's last watching the live video of this distributor and the comments and items input by the viewer at that time. For example, this advice is set as a message in the form of “[viewer's name] came to the live streaming at around [start time of the last viewing] on [day of the week of the last viewing], which was [days elapsed since the last viewing] days ago. In the last live streaming, the comment of ‘[comment's content]’ is input, and [item's name] is input [number of input times]. Please try to tell the viewer these things.” For example, [comment's content] is set to the content of one comment (e.g., “I'll be back!”) automatically selected from among a plurality of comments input by the corresponding viewer while watching the last live video. For example, the comment last input is selected. In addition, [item's name] is set to the name of one item (e.g., the item with the highest number of coins required) automatically selected from among a plurality of items input by the corresponding viewer while watching the last live video.

After generating and inputting the advice based on the basic information (step 5210) or the advice based on the viewer's previous action (step S220), the server 10, when the targeted viewer is subject to the advice regarding an anniversary (YES in step S230), generates and inputs the advice related to an anniversary (step S240). Specifically, the server 10 determines that a viewer whose elapsed period from the date of first viewing is the predetermined value (e.g., one month) or a viewer whose total number of viewings is the predetermined number (e.g., 100) is subject to the advice related to the anniversary. In addition, the advice related to the anniversary recommends topics based on the viewer's first action. For example, the recommended topics include a topic based on the date and time of the viewer's first watching a live video, the content of the comment first input, and a type of the item first input. For example, this advice is set as a message in the form of “Today is the [elapsed period] anniversary from the first viewing of [viewer's name]. You met on [first-time viewing date] ([day of the week of first-time viewing date]) at around [first-time viewing time]. The first-time comment was ‘[content of first-time comment]’. Please try to tell the viewer these things.”

Subsequently, the server 10, when the viewer that has entered the room is close to becoming a member of “core fans” (YES in step S250), generates and inputs the advice related to actions needed for the viewer's becoming a member of “core fans” (step S260). In this example, viewers are recognized as members of “core fans” when satisfying three conditions related to the number of comments, viewing duration, and the number of coins consumed, as described above. At step 5250, the viewer that has satisfied two of three conditions is determined to be close to becoming a member of “core fans”. Specifically, the advice related to the actions needed for becoming a member of “core fans” recommends topics based on the unsatisfied condition of the three conditions. For example, this advice is set as a message in the form of “[Viewer's name] is close to becoming a member of ‘core fans.’ [Number of needed comments] more comments are needed. Please tell the viewer this to improve their motivation.”

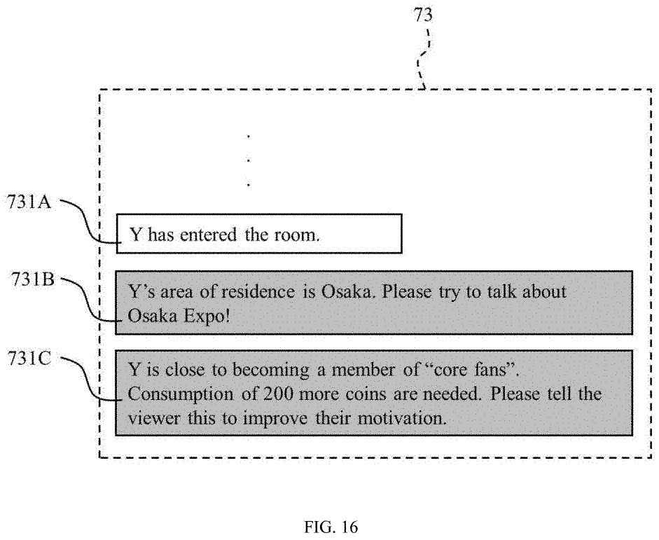

FIG. 16 illustrates the comment display area 73 in which the comment object 731 corresponding to a system comment displaying the advice related to the viewer that has entered the live streaming room is added. In the comment display area 73 in FIG. 16, following the comment object 731A regarding the system comment that notifies the viewer(Y)'s entering the room, the comment object 731B regarding the system comment that displays the advice on the topic (Osaka Expo) based on the viewer's area of residence (Osaka) is added. Subsequently, the comment object 731C corresponding to the system comment displaying the advice related to the action (consumption of 200 more coins) needed for the viewer's becoming a member of “core fans” is added in the comment display area 73.

In the comment display area 73 of this example, the comment object 731 corresponding to the advice to a distributor is displayed differently from other comment objects 731. Specifically, the background color of the comment object 731 corresponding to the advice is different from that of other comment objects 731. In other words, the comment object 731 corresponding to the advice has a dedicated background color. This configuration allows distributors to distinguish the advice to themselves from other information.

Furthermore, in the comment display area 73 of this example, the comment object 731 regarding the system comment that displays the advice related to this viewer (the object 731B or C in FIG. 16) is located next to the comment object 731 regarding the system comment that notifies the viewer's entering the room (the object 731A in FIG. 16). Specifically, when the comment object 731 notifying a viewer's entering the room is added, another comment object 731 is stopped from adding until the comment object 731 displaying the advice related to this viewer is added. This configuration allows distributors to distinguish the advice about the viewer that has entered the live streaming room.

Referring back to the flowchart in FIG. 14, the server 10 generates and inputs periodic advice (step S130) each time a predetermined time elapses (YES in step S120) between the start and end of live streaming (NO in step S160).

In this example, contents of periodic advice are differently generated according to the elapsed time from the start of live streaming. Specifically, the periodic advice based on the distributor information is generated and input when 15 minutes have elapsed since the beginning of live streaming. Similarly, the periodic advice based on distribution performance of live streaming is generated and entered when 30 minutes have elapsed since the beginning of live streaming, and the periodic advice based on an external service is generated and entered when 60 minutes have elapsed since the beginning of live streaming. When the periodic advice is input, the corresponding comment object 731 is added to the comment display area 73 to be ready to be displayed.

In this example, the periodic advice based on the distributor information is configured to be generated based on the distributor's rank order (i.e., the rank order of distribution points acquired by the distributor) within the corresponding ranking band for the day. As will be described later in detail, the rank order affects the fluctuation in the ranking meter value. For example, the advice based on the rank order is set as a message in the form of “Your current rank order in the ranking band is [rank order] (ranking meter value: [fluctuation range]). Please tell viewers this to have more support from them.”

In addition, the periodic advice based on distribution performance of live streaming in this example is configured to be generated based on the current number of viewers, the number of input comments, and the number of consumed coins in the current live streaming. For example, the advice based on the number of input comments is set as a message in the form of “The current number of comments in this live streaming is [number of comments] and the average number of comments for one live streaming of this month is [average value]. Please try to talk about this.”

Furthermore, the periodic advice based on the external service in this example is configured to be generated based on trends on “Twitter”. For example, the advice based on the trends is set as a message in the form of “The current trends on Twitter are [first trend], [second trend], [third trend], and so on. Please try to talk about these trends.”

The server 10 also generates and inputs the supervisor's advice (step S150) each time the supervisor of the distributor inputs advice (YES in step S140) until the live streaming ends (NO in step S160). When the supervisor's advice is input, the corresponding comment object 731 is added to the comment display area 73 to be ready to be displayed. In this example, the supervisor inputs the advice via the viewer screen 80.

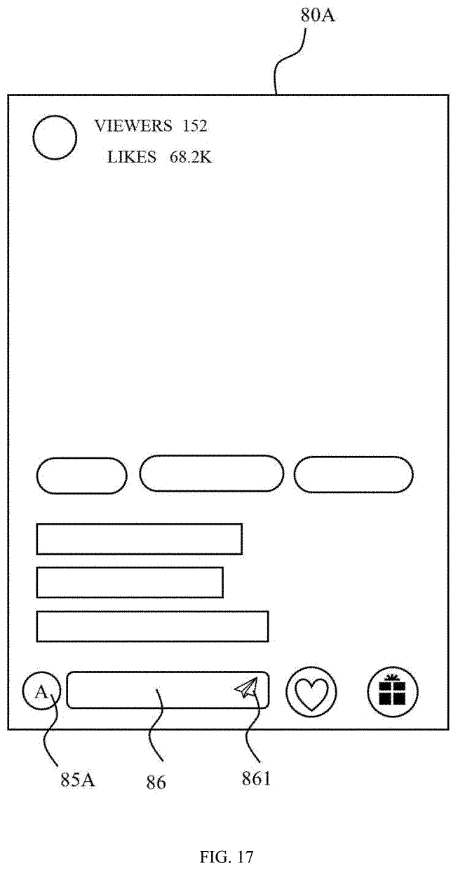

FIG. 17 illustrates the viewer screen 80A for the viewer that is a supervisor of the distributor. As shown, if the viewer is a supervisor, the input mode switching button 85A is located instead of the input mode switching button 85 used to switch between the comment input mode and the tag input mode. The supervisor of the distributor is specified by referring to the supervising distributor information in the user information table 411. The button 85A is an object that allows a supervisor to switch between the comment input mode and an advice input mode. The comment input area 86 is in the advice input mode while the input mode switching button 85A is selected. A character string input in the comment input area 86 is transmitted (input) as the advice content when the transmission object 861 is selected in the advice input mode.

The content input by the supervisor is used to be the supervisor's advice without any substantial change. For example, when the supervisor transmits the advice content such as “You should smile more.” or “Please try to make big gestures.”, the transmitted content is input as the advice without any substantial change. In another example of the present embodiment, the supervisor may input the advice via a screen for a supervisor, which is different from the viewer screen 80.

The process related to providing advice information to distributors has been described. Next, the process when the distributor ends their live streaming will be described. As described above, when the distributor selects the distribution stop button 76 on the distributor screen 70, the live streaming ends. When the live streaming ends, the server 10 sets the distribution points for the distributed live video. In this example, the distribution points are calculated based on the number of viewers (maximum value), the number of “likes”, the number of comments, and the item points. The distribution points are configured to increase as the number of viewers (maximum value), the number of likes, the number of comments, and the item points increase. The calculated distribution points are set in the distribution management table 412.

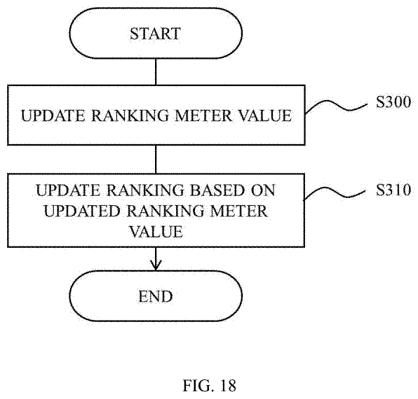

In this example, a ranking on the day is determined (updated) based on the distribution points acquired by a user on the previous day. FIG. 18 is a flowchart illustrating the process executed by the server 10 to update each user's ranking. The process is executed in the middle of every night (for example, daily at 3 o'clock).

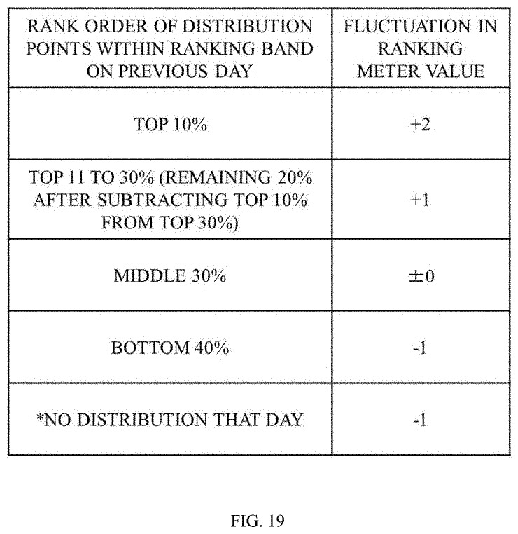

As illustrated, the server 10 updates the ranking meter value of each user (step S300). FIG. 19 is a diagram illustrating a rule for updating the ranking meter value. As shown, the ranking meter value fluctuates based on the rank order of distribution points acquired by a user on the previous day within a ranking band to which the user belongs. The distribution points gained by a specific user on the previous day are calculated by referring to the distributor user account, the distribution date and time, and the distribution points in the distribution management table 412. When the user performs several live streams (distributes several live videos) on the same day, the distribution points acquired in these streams are added together.

Specifically, as illustrated in FIG. 19, when the rank order of the distribution points within the ranking band is included in the top 10%, the fluctuation in ranking meter value is “+2” (an increase of two points) in the rule for updating a ranking meter value. Similarly, the fluctuation when the rank order is included in the top 11 to 30% (remaining 20% after subtracting the top 10% from the top 30%) is “+1,” the fluctuation when the rank order is included in the middle 30% (top 31 to 60%) is “±0” (no increase or decrease), and the fluctuation when the rank order is included in the bottom 40% is “−1” (a decrease of one point). When no live streaming is performed on the previous day, the fluctuation in ranking meter value is “−1” regardless of the rank order within the ranking band.

In step S300, the ranking meter value of each user is updated in accordance with the update rule illustrated in FIG. 19.

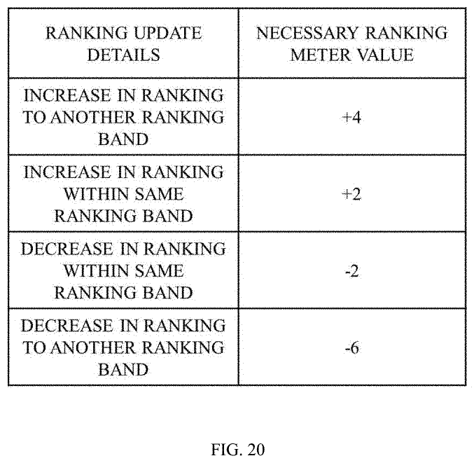

Referring back to the flowchart in FIG. 18, after updating the ranking meter value for each user, the server 10 updates the ranking based on the updated ranking meter value (Step S310). FIG. 20 is a diagram illustrating a correspondence relationship between the ranking update details and the necessary ranking meter values. As shown, the ranking meter value needed for a user to move up in ranking to another ranking band (that is, to move up in ranking from the highest ranking in each ranking band) is +4. In other words, a user belonging to the highest ranking (for example, A+) in each ranking band moves up in ranking to the lowest ranking (for example, S−) in the one level higher ranking band when the ranking meter value reaches +4. Further, the ranking meter value needed for a user to move up in ranking within the same ranking band (that is, to move up in ranking from the middle or lowest ranking in each ranking band) is +2. In other words, a user belonging to the middle or lowest ranking (for example, B or B−) in each ranking band moves up in ranking to the one level higher ranking (for example, B+or B) within the same ranking band when the ranking meter value reaches +2.

Similarly, as illustrated in FIG. 20, the ranking meter value needed for a user to move down in ranking within the same ranking band (that is, to move down in ranking from the highest or middle ranking within each ranking band) is −2. In other words, a user belonging to the highest or middle ranking (for example, B+or B) in each ranking band moves down in ranking to the one level lower ranking (for example, B or B−) within the same ranking band when the ranking meter value reaches −2. Further, the ranking meter value needed for a user to move down in ranking to another ranking band is −6. In other words, a user belonging to the lowest ranking (for example, A−) in each ranking band moves down in ranking to the highest ranking (for example, B+) within the one level lower ranking band when the ranking meter value reaches −6. In this way, the absolute value of the necessary ranking meter value for moving up or down to another ranking band is larger than that for moving up or down within the same ranking band in this example. This configuration can reduce moving up or down abruptly in ranking within a short period.

In step S310, the ranking is updated based on the ranking meter value in accordance with the correspondence relationship illustrated in FIG. 20. The ranking meter value of a user whose ranking has been updated (whose ranking has increased or decreased) is cleared to zero.

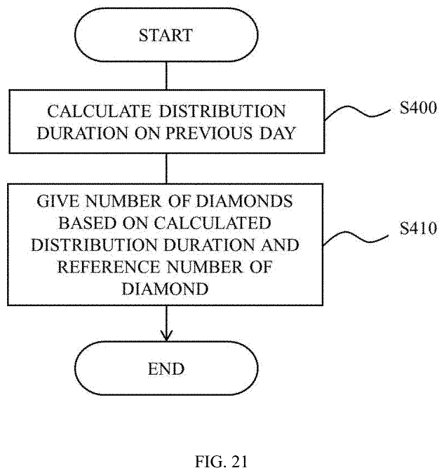

In this example, the virtual diamond as a reward is given to distributor users based on the distribution duration and the ranking on the previous day. FIG. 21 is a flowchart illustrating the process executed by the server 10 for giving a diamond to each distributor. This process is executed in the middle of every night. For example, it is executed at a specific time (for example, daily at 0 o'clock) before the process illustrated in FIG. 18 to update each user's ranking is executed.

As illustrated, the server 10 calculates the distribution duration on the previous day of each user (step S400). Specifically, the distribution duration on the previous day of a specific user is specified by referring to the distributor user account, the distribution date and time, and the distribution duration in the distribution management table 412. When a user performs several live streams (distributes several live videos) on the same day, the distribution durations of these streams are added together.

The server 10 then gives diamonds to each user based on the calculated distribution duration and the reference number of diamonds (step S410). Specifically, the number of diamonds given to each user is obtained by multiplying the calculated distribution duration by the reference number of diamonds. The reference number of diamonds is preset for each ranking to increase with a higher ranking. The reference number of diamonds corresponding to the ranking on the previous day of each user is applied. When the diamonds are given to the user, the number of held diamonds in the user information table 411 is updated. In this example, users can exchange diamonds for coins or actual currency.

In the example described above, the advice related to a viewer is generated and input each time a new viewer has entered the room. In another example of the present embodiment, the advice regarding a viewer may be generated and input upon the viewer's action different from the entering the room. For example, the advice related to a viewer may be generated and input when this viewer first inputs a comment or item after entering the room.

In the example described above, the server 10 generates and inputs the advice based on various kinds of information regarding a viewer, generates and inputs the periodic advice based on the distributor information, live video distribution performance, and an external service, and generates and inputs the supervisor's advice. However, these are examples of the advice information in the present embodiment. In another example of the present embodiment, the advice may be generated based on various kinds of information other than the information described above. For example, advice based on the update history of a viewer's profile (e.g., the advice recommending topics regarding an updated portion of a viewer's profile) may be generated.

In the example described above, the advice may be generated through video image and/or audio analysis during live streaming. For example, a distributor's face (expression) included in the video may be analyzed, and then the advice of “You should smile more.” may be generated when the percentage of the period in which a distributor smiles in the predetermined period is lower than a predetermined value. In addition, a distributor's emotion is analyzed based on the voice included in the video, and then the advice of “You should speak more cheerfully.” may be generated when the percentage of the period in which a distributor is cheerful in the predetermined period is lower than a predetermined value. A learned model developed through machine learning using a large amount of training data may achieve such an analysis of expression or emotion.

In the example described above, the comment object 731 corresponding to a system comment that displays the advice to a distributor is added to the comment display area 73 to be ready to be displayed. In another example of the present embodiment, the advice information to a distributor may be displayed another area other than the comment display area 73. For example, the advice may be displayed on the distributor screen 70 like subtitles at the predetermined location.

The live video distribution server 10 according to the present embodiment described above, generates the advice information to a distributor during the live video distribution and displays the advice information on the distributor screen (e.g., adds the corresponding comment object 731 to the comment display area 73 of the distributor screen 70). This configuration allows the distributor to perform the live video distribution while referring to the advice information presented in real-time. Thus, the live video distribution server 10 may help users appropriately perform the live video distribution.

The processing and procedures described in the specification may be achieved by software, hardware, or any combination of these in addition to what was explicitly described. For example, the processing and procedures described in the specification may be achieved by implementing a logic corresponding to the processing and procedures in a medium such as an integrated circuit, a volatile memory, a non-volatile memory, and a magnetic disk. Further, the processing and procedures described in the specification can be implemented as a computer program corresponding to the processing and procedures and can be executed by various kinds of computers.

Although the processing and procedures described in the specification are described as being executed by a single device, a single piece of software, a single component, or a single module, such processing or procedures can be executed by a plurality of devices, a plurality of pieces of software, a plurality of components, and/or a plurality of modules. Further, the software and hardware elements described in the specification can also be achieved by integrating them into fewer components or breaking them down into more components.

In the specification, when a component of the present disclosure is described as either one or a plurality of things, the component may be either one or a plurality of things, except when the context indicates otherwise.

What is claimed is:

1. A system, comprising one or more computer processors that execute machine-readable instructions to perform:
displaying a live video distributed by a distributing user on a first screen presented to a viewing user;
generating advice information to the distributing user during distribution of the live video; and
displaying the advice information on a second screen presented to the distributing user, wherein
the displaying of the advice information includes not displaying the advice information on the first screen.

2. The system of claim 1, wherein the generating of the advice information includes generating the advice information based at least on viewing user information related to the viewing user.

3. The system of claim 2, wherein the viewing user information includes at least one of use history of the viewing user and update history of the viewing user's profile.

4. The system of claim 1, wherein the displaying of the advice information includes displaying the advice information related to the viewing user in response to the viewing user performing a predetermined action.

5. The system of claim 1, wherein the generating of the advice information includes generating the advice information based at least on information input by a user supervising the distributing user.

6. The system of claim 1, wherein the generating of the advice information includes generating the advice information based at least on distribution performance information related to distribution performance of the live video.

7. The system of claim 1, wherein the generating of the advice information includes generating the advice information based at least on distributing user information related to the distributing user.

8. The system of claim 1, wherein the generating of the advice information includes generating the advice information based at least on external service information obtained from an external service.

9. The system of claim 1, wherein the generating of the advice information includes generating the advice information through analysis of images and/or audio included in the live video.

10. The system of claim 1, wherein the displaying of the advice information includes displaying, in a comment display area that is included in the second screen and displays at least a first comment corresponding to an action performed by the viewing user, a second comment corresponding to the advice information.

11. The system of claim 10, wherein the comment display area is configured to display the first comment in a first manner and to display the second comment in a second manner that is different from the first manner.

12. The system of claim 10, wherein the comment display area is configured to display a plurality of comments to be arranged in order of occurrence.

13. The system of claim 10, wherein the displaying of the advice information includes displaying, in the comment display area, the second comment corresponding to the advice information related to the viewing user next to the first comment corresponding to the action performed by the viewing user.

14. A method executed by one or more computers, the method comprising:
displaying a live video distributed by a distributing user on a first screen presented to a viewing user;
generating advice information to the distributing user during distribution of the live video; and
displaying the advice information on a second screen presented to the distributing user, wherein
the displaying of the advice information includes not displaying the advice information on the first screen.

15. A non-transitory computer-readable medium including a program, wherein the program causes one or more computers to execute:
displaying a live video distributed by a distributing user on a first screen presented to a viewing user;
generating advice information to the distributing user during distribution of the live video; and
displaying the advice information on a second screen presented to the distributing user, wherein
the displaying of the advice information includes not displaying the advice information on the first screen.
